(19) United States
(12) Patent Application Publication
(10) Pub. No.: US 2023/0087719 A1
(43) Pub. Date: Mar. 23, 2023

(54) SLOW-RELEASE POTASSIUM AND SULFUR FERTILIZER AND METHODS FOR MAKING SAME

(71) Applicant: OSTARA NUTRIENT RECOVERY TECHNOLOGIES INC., Vancouver (CA)

(72) Inventors: Roland LEATHERWOOD, Columbus, OH (US); Robert VAN SPINGELEN, Gravenhage (NL); Ahren BRITTON, North Vancouver (CA)

(21) Appl. No.: 17/904,206

(22) PCT Filed: Feb. 19, 2021
(86) PCT No.: PCT/CA2021/050193

§ 371 Date: Aug. 12, 2022

Related U.S. Application Data
(60) Provisional application No. 62/979,714, filed on Feb. 21, 2020.

(51) Int. Cl. C05G 1/00; C05G 5/12; C05B 7/00; C05D 1/02

(52) U.S. Cl. CPC C05G 1/00; C05G 5/12; C05B 7/00; C05D 1/02

(57) ABSTRACT

A fertilizer comprises a slow release source of phosphorus and a slow release source of sulfur. The slow release source of phosphorus may be struvite. The slow release source of sulfur may be polyhalite. The fertilizer may further contain a fast release source of phosphorus such as a water-soluble phosphorus-containing material. The fertilizer may be in the blended form or in the co-granular form. A number of methods may be used to make such co-granular fertilizers.

### CROSS-REFERENCE TO RELATED APPLICATION

This application claims priority from U.S. application No. 62/979,714 filed 21 Feb. 2020 and entitled SLOW-RELEASE POTASSIUM AND SULFUR FERTILIZER AND METHODS FOR MAKING SAME which is hereby incorporated herein by reference for all purposes. For purposes of the United States of America, this application claims the benefit under 35 U.S.C. § 119 of U.S. application No. 62/979,714 filed 21 Feb. 2020 and entitled SLOW-RELEASE POTASSIUM AND SULFUR FERTILIZER AND METHODS FOR MAKING SAME.

### TECHNICAL FIELD

The invention relates to fertilizers for plants. Some embodiments of the invention provide fertilizers that provide a sustained source of nutrients into the late growing season. Some embodiments of the invention provide methods for making particulate fertilizers.

### BACKGROUND

Nitrogen (N), phosphorus (P), and potassium (K) are the main nutrients needed for plant growth and development. For example, phosphorus helps transfer energy from sunlight to plants, stimulates early root and plant growth, and hastens maturity. Sulfur (S) is one of the secondary nutrients required by plants for normal, healthy growth. Plants use sulfur in the process of producing proteins, amino acids, enzymes and vitamins. Sulfur is also involved in energy-producing processes in plants. Plants absorb phosphorus and sulfur in the forms of orthophosphates (H₂PO₄⁻ and HPO₄²⁻) and sulphate (SO₄⁻) respectively. Fertilizers provide such nutrients in available forms for plants to take up as required to promote plant growth and development. Fertilizers may additionally contain other active materials including macronutrients, such as magnesium (Mg) and calcium (Ca), micronutrients, such as boron (B), chlorine (Cl), copper (Cu), iron (Fe), manganese (Mn), molybdenum (Mo), zinc (Zn), and nickel (Ni), pesticides, herbicides, etc.

One of the problems with many fertilizer compositions is that when fertilizer is applied to a crop, a fraction of water-soluble components of the fertilizer is rapidly absorbed by plants as nutrients. The unabsorbed water-soluble components rapidly permeate the soil and may be lost via leaching, run-off or chemical binding with soil minerals. Limited quantities of nutrients remain in the late growing season. This is undesirable as some crops (e.g., corn, canola, wheat and soy) and soil conditions require a sustained source of nutrients available for uptake during the late growing season in order to maximize crop yield.

There is a need for fertilizers that can supply plants with a sustained source of nutrients, especially phosphorus and sulfur, over a growing season particularly into the late season.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a fertilizer comprising a slow release source of phosphorus and a slow release source of sulfur. The fertilizer slowly releases phosphorus and sulfur in plant-available forms. In some embodiments, the slow release source of phosphorus is struvite. In some embodiments, the slow release source of sulfur is polyhalite. The ratio of available sulfur to available phosphate expressed as phosphorus pentoxide may be in the range of from about 2% to about 25%. In some embodiments, the ratio of available sulfur to available phosphate expressed as phosphorus pentoxide is about 5%. In some embodiments, the ratio of available sulfur to available phosphate expressed as phosphorus pentoxide is no less than about 2% and no greater than about 25%. The fertilizer may also include a fast-release source of phosphorus. The fast-release source of phosphorus may be a water-soluble phosphorus-containing material, for example, monoammonium phosphate (MAP) and/or diammonium phosphate (DAP). Other examples of water soluble phosphous containing materials that may be included in the fertilizer include phosphoric acid, single super phosphate (SSP), double super phosphate (DSP), triple super phosphate (TSP), and dicalcium phosphate. The fertilizer may be in a co-granular form or a blended form.

In some embodiments, the granular fertilizer has granules with a size of at least SGN 60. The granules may comprise particles of struvite and particles of polyhalite with sizes of about SGN 10 or less.

In some embodiments, the struvite content of the fertilizer is in the range of from about 65% to about 99% by weight, and the polyhalite content of the fertilizer is in the range of from about 35% to about 1% by weight. In some embodiments, the content of phosphorus containing materials in the fertilizer (e.g. struvute and water-soluble phosphorus-containing material) is in the range of from about 55% to about 99% by weight, and the polyhalite is in the range of from about 1% to about 45% by weight.

In some embodiments:
the fertilizer is made up of granules which include both a slow-release source of phosphorus (e.g. struvite) and a slow release source of sulfur (e.g. polyhalite);
the fertilizer is made up of granules which include both a slow-release source of phosphorus (e.g. struvite) and a slow release source of sulfur (e.g. polyhalite) and a fast release source of phosphorus (e.g. a water-soluble phosphorus containing material such as MAP or DAP);
the fertilizer is a blend of granules comprising a slow release source of sulfur (e.g. polyhalite) and other granules containing phosphorus. The granules containing phosphorus may, for example, comprise: both a slow-release source of phosphorus (e.g. struvite) and a fast release source of phosphorus (e.g. a water-soluble phosphorus containing material such as MAP or DAP); and/or granules containing a slow-release source of phosphorus and other granules containing a fast release source of phosphorus; or granules containing a slow-release source of phosphorus; and
the fertilizer is a blend of granules comprising a slow release source of sulfur (e.g. polyhalite) together with a fast release source of phosphorus and other granules comprising a slow-release source of phosphorus (e.g. struvite) together with a fast release source of phosphorus (e.g. a water-soluble phosphorus containing material such as MAP or DAP).

In some embodiments the fertilizer is made up of granules in which a slow release source of sulfur (e.g. polyhalite) and one or both of a slow-release source of phosphorus (e.g. struvite) and a fast release source of phosphorus make up at least 80% or 90% or 95% or 98% by weight of all plant nutrients in the fertilizer.

Other aspects of the invention provide methods for making granular fertilizers. In some embodiments, the methods involve granulating a mixture of raw materials. In some embodiments, the raw materials comprise struvite fines and polyhalite fines. In some embodiments, the raw materials comprise struvite fines, a water-soluble phosphorus-containing material and polyhalite fines. In other embodiments, the raw materials comprise one or more of ammonia, phosphoric acid, monoammonum phosphate, diammonium phosphate and magnesium oxide to form struvite and the water-soluble phosphorus-containing material.

In some embodiments, the granulation step comprises adding water and/or steam and/or a binder to produce a slurry comprising desired proportions of struvite, polyhalite and, optionally, a water-soluble material containing phosphorus.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1A is a schematic diagram illustrating a fertilizer blend 10A according to an embodiment.

FIG. 1B is a schematic diagram illustrating a fertilizer blend 10B according to another embodiment.

FIG. 2A is a magnified view of a fertilizer co-granule 20A according to an embodiment.

FIG. 2B is a magnified view of a fertilizer co-granule 20B according to another embodiment.

FIG. 3 is a process diagram illustrating a first example method for making fertilizer granules.

FIG. 4 is a process diagram illustrating a first example method for making fertilizer granules.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense. phosphoric acid solubility

An aspect of the invention relates to a fertilizer that slowly releases phosphorus and sulfur after it is applied to a crop. The fertilizer may comprise two or more materials which include at least one slow-release source of phosphorus and at least one slow-release source of sulfur. The slow-release source of phosphorus may, for example, be struvite. The slow-release source of sulfur may, for example, be polyhalite.

A “slow-release source” is a source of nutrient which has low solubility in water, allowing nutrients contained within the source to release to plants or soil over an extended period of time. A non-limiting example of a slow-release source of phosphorus has a solubility of about 170 to 180 mg/L at 25° C. in water. A non-limiting example of a slow-release source of sulfur has a solubility of about 12 to 30 g/L at 25° C. in water.

A “fast-release source” is a source of nutrient which has high solubility in water, allowing fast release of nutrients contained within the source to plants or soil. The solubility of a fast-release source of phosphorus may for example be in the range of from about 300 g/L to about 6000 g/L at 20° C. in water.

Struvite has the formula MgNH₄PO₄.6H₂O and is also known as magnesium-ammonium-phosphate. Struvite can be obtained as a by-product of waste water processes. Harvesting struvite from wastewater is described for example in U.S. Pat. Nos. 7,622,047 and 8,444,861. Struvite is composed of approximately 12-13% phosphorus (or 28-29% phosphorus pentoxide, or commonly known as phosphoric acid, P₂O₅), 5% nitrogen and 9-10% magnesium by weight.

Polyhalite is a naturally occurring evaporate mineral with the formula K₂Ca₂Mg(SO₄)₄.2H₂O composed of approximately 13.5-14% potassium oxide (K₂O), 18.8-19.2% sulfur, 12.2-15.4% calcium and 3.3-3.6% magnesium by weight.

Struvite and polyhalite both have low solubility in water, allowing struvite and polyhalite to release phosphorus and sulfur at a lower rate. The slow-release nature of struvite and polyhalite can provide a sustained source of phosphorus and sulfur over an entire growing season, and particularly into the late season when amounts of phosphorus and sulfur available for take up by plants are normally limited. A fertilizer that releases phosphorus and sulfur at a lower rate can also provide a better opportunity for plants to take up these nutrients. Improved nutrient uptake increases nutrient use efficiency and decreases the amount of fertilizer required to be applied to soil for optimum plant growth over a growing season. The decreased quantity and number of fertilizer applications means less fertilizer may be used, there may be reduced soil compaction as a result of fewer applications, and less fuel or energy may be used to apply the fertilizer. All of these reduce the impact on the environment. The prolonged release of sulfur also has the environmental benefit of reducing the risk of sulfur leaching.

The fertilizer composition optionally additionally includes a source of fast-release phosphorus. The source of fast-release phosphorus may be a water-soluble phosphorus-containing material that is derived from a suitable phosphate, for example, phosphoric acid, single super phosphate (SSP), double super phosphate (DSP), triple super phosphate (TSP), monoammonium phosphate (MAP), diammonium phosphate (DAP), dicalcium phosphate, or a combination of one or more of the foregoing. The water-soluble phosphorus-containing material may be intermixed with particles of struvite to produce a slow- and fast-release phosphorus material. In some embodiments, the weight ratio of struvite to the water-soluble phosphorus-containing material is about 20% to 40% struvite to about 60% to 80% water-soluble phosphorus-containing material. In some embodiments, the weight ratio of struvite to the water-soluble phosphorus-containing material is about 25% to 38% struvite to about 62% to about 75% water-soluble phosphorus-containing material. Examples of a composition providing slow- and fast-release phosphorus materials and example methods for making same are described in WO 2014/198000 (Clark et al.), which is hereby incorporated herein by reference.

Other nutrients such as additional sources of nitrogen, potassium, sulfur, or any other nutrient or micronutrient useful for plant growth or health and/or other active materials such as pesticides, selective herbicides, and the like, may optionally be included in the fertilizer composition.

In some embodiments, the solubility of the slow-release source of phosphorus is less than about 100 g/L, or less than about 10 g/L, or less than about 1 g/L in water at 25° C. In some embodiments, the solubility of the fast-release source of phosphorus is more than about 100 g/L, or more than about 200 g/L in water at 20° C. In some embodiments, the solubility of the fast-release source of phosphorus is in the range of from 200 g/L to 8000 g/L in water at 20° C.

In some embodiments, the slow-release source of phosphorus results in less than about 100 g/L, or less than about 10 g/L, or less than about 1 g/L of phosphorus pentoxide being dissolved in water at 25° C.

In some embodiments, the fast-release source of phosphorus results in more than about 300 g/L of phosphorus pentoxide being dissolved in water at 20° C. In some embodiments, the fast-release source of phosphorus results in the range from about 300 g/L to 9000 g/L of phosphorus pentoxide being dissolved in water at 20° C.

In some embodiments, the solubility of the slow-release source of sulfur in water at 25° C. is less than about 100 g/L, or less than about 50 g/l.

In some embodiments, the fertilizer composition consists essentially of struvite and polyhalite (i.e. the composition does not include other materials that significantly affect its performance as a fertilizer). In these embodiments, struvite and polyhalite supply all of the nutrients that the fertilizer releases for plant growth (i.e. additional sources of nutrients or micronutrients are not included in the fertilizer composition).

In some embodiments, the fertilizer composition consists essentially of struvite, a fast release source of phosphorus, and polyhalite. The fast release source of phosphorus may be a water-soluble phosphorus-containing material such as monoammonium phosphate or diammonium phosphate. These embodiments may provide the nitrogen, phosphorus, potassium, sulfur, magnesium and calcium required by a crop in one fertilizer.

In some embodiments, the amount of struvite or the slow- and fast-release phosphorus material (i.e., a mixture of struvite and a water-soluble phosphorus-containing material) in the fertilizer composition is similar to the polyhalite content (e.g. within 5% of the polyhalite content by weight). In some embodiments, the amount of struvite or the slow- and fast-release phosphorus material is different from the polyhalite content. For example the struvite content or the slow- and fast-release phosphorus material content may be higher than the polyhalite content. In some embodiments, the amount by weight of phosphorus containing material (combined slow-release phosphorus containing material and fast-release phosphorus containing material, if present) is about 1.5 times to about 50 times greater than the amount of polyhalite, including any value therebetween, e.g., 2, 4, 6, 8, 10, 12, 14, 16, 18, 20, 22, 24, 26, 28, 30, 32, 34, 36, 38, 40, 42, 44, 46, 48 times, etc. The relative amounts of struvite or the slow- and fast-release phosphorus material and polyhalite can vary widely. In some embodiments the amount of each of slow-release and fast-release phosphorus containing material in the fertilizer by weight exceeds the amount of polyhalite in the fertilizer by weight by at least 3%.

In some embodiments, the weight ratio of available sulfur (S) to available phosphate expressed as phosphorus pentoxide (P₂O₅) is in the range of from about 1% to about 40%, including any value therebetween, e.g., 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, and 39%. In some embodiments, the weight ratio of sulfur to phosphate expressed as phosphorus pentoxide is no less than about 2%. In some embodiments, the weight ratio of sulfur to phosphate expressed as phosphorus pentoxide is no greater than 25%. In some embodiments, the weight ratio of sulfur to phosphate expressed as phosphorus pentoxide is about 5%.

In some embodiments in which the fertilizer composition includes struvite and polyhalite, the content of struvite may be in the range of from about 65% to about 99% by weight, including any value therebetween, e.g., 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97% and 98%. In some embodiments, the content of struvite is in the range of from about 73% to about 97% by weight. In these embodiments, the content of polyhalite may be in the range of from about 1% to about 35% by weight, including any value therebetween, e.g., 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33% and 34%. In some embodiments, the content of polyhalite is in the range of from about 3% to about 27% by weight.

In some embodiments in which the fertilizer composition includes both a slow- and fast-release phosphorus material and polyhalite, the combined content of the slow- and fast-release phosphorus material is in the range of from about 55% to about 99% by weight, including any value therebetween, e.g., 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97% and 98%. In some embodiments, the content of the slow- and fast-release phosphorus material is in the range of from about 64% to about 96% by weight. In these embodiments, the content of polyhalite may be in the range of from about 1% to about 45% by weight, including any value therebetween, e.g., 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, and 44%. In some embodiments, the content of polyhalite is in the range of from about 4% to about 36% by weight.

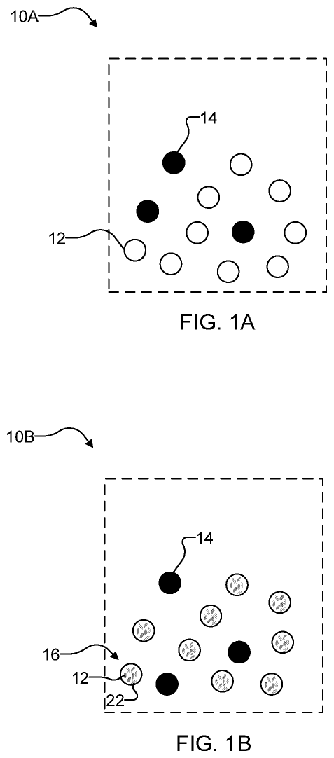

The fertilizer may be in the form of a blended fertilizer. Blended fertilizers are produced by mechanically mixing two or more granular materials. The two or more granular materials may remain as separate granules upon mixing. FIG. 1A is a schematic diagram of an example blended fertilizer 10A according to an example embodiment. Blended fertilizer 10A comprises small particles of struvite 12 and small particles of polyhalite 14. The small particles of struvite 12 and polyhalite 14 are thoroughly mixed prior to application to ensure that the plants obtain the necessary nutrients from both struvite and polyhalite from one application of blended fertilizer 10A.

FIG. 1B is a schematic diagram of a blended fertilizer 10B according to another example embodiment. Blended fertilizer 10B comprises granules 16 and particles of polyhalite 14. Granules 16 comprise small particles of struvite 12 evenly intermixed with a water-soluble phosphorus-containing material 22.

In some embodiments, particles of struvite 12, polyhalite 14 and water-soluble phosphorus-containing material 22 (if present) are identical or similar in size. In some embodiments, particles of struvite 12, polyhalite 14 and water-soluble phosphorus-containing material 22 (if present) have different sizes. It is preferred that particles of struvite 12, polyhalite 14 and water-soluble phosphorus-containing material 22 (if present) have substantially similar sizes to avoid segregation during distribution, storage and application of blended fertilizers 10A,B.

In some embodiments, the diameter of the struvite particles, polyhalite particles, and granules comprising struvite and water-soluble phosphorus-containing material is in the range of from about 0.1 to about 20 mm, including any value therebetween, e.g., 0.2 mm, 0.3 mm, 0.4 mm, 0.5 mm, 0.6 mm, 0.7 mm, 0.8 mm, 0.9 mm, 1 mm, 2 mm, 3 mm, 4 mm, 5 mm, 6 mm, 7 mm, 8mm, 9 mm, 10 mm, 11 mm, 12 mm, 13 mm, 14 mm, 15 mm, 16 mm, 17 mm, 18 mm and 20 mm.

In some embodiments, the diameters of the struvite particles, polyhalite particles, and granules comprising struvite and water-soluble phosphorus-containing material are in the range of 1 to 6 mm. In some embodiments, the diameters of the struvite particles, polyhalite particles, and granules comprising struvite and water-soluble phosphorus-containing material are in the range of 2 to 4 mm. In some embodiments, at least 70% (including e.g., 72%, 74%, 76%, 78%, 80%, 82%, 84%, 86%, 88%, 90%, 92%, 94%, 96%, 98%) of each of the struvite particles, polyhalite particles, and granules comprising struvite and water-soluble phosphorus-containing material in the fertilizer have diameters between about 2 mm to about 4 mm. In some embodiments, about 90% of each of the struvite particles, polyhalite particles, and granules comprising struvite and water-soluble phosphorus-containing material have diameters between about 2 mm to about 4 mm.

In some embodiments the fertilizer is a blended fertilizer comprising at least two different types of granules having different compositions. The different granules may be configured (e.g. in size, surface morphology, density, material composition, and/or binder) so as to continue to release contained nutrients into the soil for substantially the same amount of time when applied to a crop.

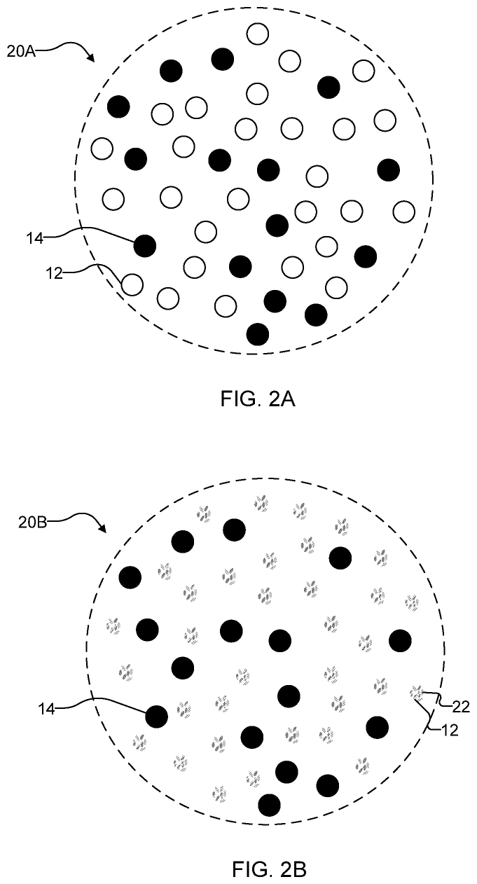

The fertilizer may be in the form of a co-granulated fertilizer. Co-granulated fertilizers are produced by combining two or more materials to form homogenous granules by granulation. FIG. 2A is a magnified cross-section of an example fertilizer co-granule 20A. Co-granule 20A comprises small particles of struvite 12 intermixed with small particles of polyhalite 14. FIG. 2B is a magnified cross-section of an example fertilizer co-granule 20B. Co-granule 20B comprises a mixture of particles of polyhalite 14, struvite 12 and water-soluble phosphorus-containing material 22. Particles of struvite 12, polyhalite 14 (and water-soluble phosphorus-containing material 22 in the FIG. 20B co-granule) may be uniformly distributed throughout co-granule 20A, 20B.

Co-granules 20A, 20B may be characterized by a diameter of about 1 mm to 6 mm, including any value therebetween e.g., 2 mm, 3 mm, 4 mm, and 5 mm. Particle sizes may be described by a size guide number (SGN). SGN is given by the diameter of the median granule size in millimeters multiplied by 100. For example, a SGN of 311 corresponds to a median particle size of 3.11 mm. Co-granules 20A, 20B may have a size at or between about size guide number (SGN) 60 to SGN 600, including any value therebetween, e.g., 80 SGN, 100 SGN, 120 SGN, 140 SGN, 160 SGN, 180 SGN, 200 SGN, 220 SGN, 240 SGN, 260 SGN, 280 SGN, 300 SGN, 320 SGN, 340 SGN, 360 SGN, 380 SGN, 400 SGN, 420 SGN, 440 SGN, 460 SGN, 480 SGN, 500 SGN, 520 SGN, 540 SGN, 560 SGN and 580 SGN. In some embodiments, co-granules 20A, 20B have a size between about 100 SGN to 400 SGN.

The particles of struvite 12, polyhalite 14 and water-soluble phosphorus-containing material 22 in co-granules 20A or 20B preferably have characteristic dimensions that are smaller by a factor of 100 times or more than the characteristic dimensions of co-granules 20A, 20B (e.g., not exceeding about 0.1 mm (SGN 10 or passing 150 mesh size screen) in some embodiments, not exceeding about 0.3 mm (SGN 30 or passing 70 mesh size screen) in some embodiments, and not exceeding about 7.5 μm (SGN 7.5 or passing 200 mesh size screen) in other embodiments.

In some embodiments, co-granules 20A as shown in FIG. 2A include particles of struvite 12 and polyhalite 14 that are identical or similar in size. Co-granules 20A as shown in FIG. 2A have particles of struvite 12 and polyhalite 14 of different sizes. In some of the FIG. 2B embodiments, one or more of the particles of struvite 12, water-soluble phosphorus-containing material 22, and polyhalite 14 are identical or similar in size. In some of the FIG. 2B embodiments, one or more of the particles of struvite 12, water-soluble phosphorus-containing material 22, and polyhalite 14 have different sizes.

In some embodiments, co-granules 20A, 20B are spherical or substantially spherical in shape. In some embodiments, co-granules 20A, 20B are elliptical or substantially elliptical in shape. Co-granules 20A, 20B may have an angular shape (i.e., a shape having one or more sharp angles), which may result from the fracturing and/or sizing of the granules during their production. Co-granules 20A, 20B may have other shapes.

Struvite 12 and polyhalite 14 may be in the form of distinguishable particles in co-granules 20A. Struvite 12, water-soluble phosphorus-containing material 22 and polyhalite 14 may be in the form of distinguishable particles in co-granules 20B. In some embodiments, co-granule 20A is in the form of layers of struvite 12 and polyhalite 14, and co-granule 20B is in the form of layers of struvite 12, water-soluble phosphorus-containing material 22 and polyhalite 14. Co-granules 20A, 20B may have alternating layers of materials.

Struvite 12, water-soluble phosphorus-containing material 22 (if present) and polyhalite 14 may be in the form of substantially indistinguishable particles (i.e., the individual components of the co-granules cannot be easily distinguished from one another). Co-granules 20A, 20B containing struvite 12, polyhalite 14 and water-soluble phosphorus-containing material 22 (if present) may be combined to form a substantially homogenous mixture of mineral particles. In some embodiments, struvite 12, polyhalite 14 and water-soluble phosphorus-containing material 22 (if present) are combined to form an essentially homogenous mixture of mineral particles within co-granules 20A, 20B. In these embodiments, struvite 12, polyhalite 14 and water-soluble phosphorus-containing material 22 may be in the form of very small particles that are indistinguishable without a microscope.

Co-granules 20A, 20B may be substantially uniform in size. In some embodiments, there is heterogeneity to the size of co-granules 20A, 20B. In some embodiments, fertilizers comprise mixtures of different sizes of co-granules 20A, 20B. In other embodiments, fertilizers comprise mixtures of co-granules 20A, 20B having different compositions of struvite 12, polyhalite 14 and, where present, water-soluble phosphorus-containing material 22. In yet other embodiments, fertilizers comprise mixtures of co-granules 20A, 20B having different distributions of struvite 12, polyhalite 14 and, where present, water-soluble phosphorus-containing material 22.

Co-granules 20A, 20B may optionally comprise a binder that helps to bind together particles of struvite 12 and polyhalite 14, or granules 16 and polyhalite 14. In some embodiments, the binder is a calcium lignosulphonate. In some embodiments, the binder is starch. In some embodiments, the binder is molasses. In some embodiments, the binder is MAP. In some embodiments, the binder is a reactively formed struvite, or a reactively formed water-soluble phosphate source such as monoammonium phosphate or diammonium phosphate that is formed from reacting raw materials or slurries of the raw materials in the granulation process.

Co-granules 20A, 20B may further optionally be coated with a coating. In one embodiment, the coating is a biological agent. In yet other embodiments, the coating comprises plant-growth promoting rhizobacteria, such as rhizobium, azotobacter, azospirillum, and/or cyanobacteria. In further embodiments, the coating comprises other materials that may enhance plant growth. In other embodiments, the coating comprises one or more materials that may assist in the controlled release of phosphorus, such as a thermoplastic or a polymer.

Co-granules 20A, 20B may include one or more additional minerals. The one or more additional minerals may be a mineral that is closely related to struvite 12 or water-soluble phosphorus-containing material 22. The one or more additional minerals may be raw materials used in the production of co-granules 20A, 20B during the granulation process, reaction intermediates formed during the process, or other reaction impurities. Examples of such minerals include dittmarite, schertelite, periclase, langbeinite, gypsum, and the like. The amount of additional minerals contained in co-granules 20A, 20B may be selected based on factors such as the source and purity of the raw materials, the equipment used in the granulation process, and the conditions under which the co-granules are formed (e.g., the pH, moisture content, temperature, reaction time, etc.).

In some embodiments, co-granules 20A, 20B comprise at least about 25% to about 30% by weight of products of chemical reactions that are formed in the granulation process. These products may comprise reactively formed struvite sources and/or reactively formed water-soluble phosphate-containing material sources, formed from the conversion of one or more raw materials such as ammonia, phosphoric acid, monoammonium phosphate, diammonium phosphate, magnesium oxide and the like. These products can act as a cement or binder that provides the structural integrity of co-granules 20A, 20B.

Crush strength or hardness is a metric used to indicate how much pressure is required to break a single granule. In some embodiments, the crush strength of co-granules 20A, 20B is greater than about 3 lbs. In some embodiments, the crush strength of co-granules 20A, 20B is greater than about 5 lbs. Fertilizer granules optimally have sufficient structural strength to withstand storage, handling, transport, and use (e.g., spreading on or into the agricultural land) without suffering from substantial breakage or attrition. The degree of attrition (or attrition resistance) of the fertilizer granules may be assessed by any suitable attrition testing methods such as the IFDC-S107 test method after the granulation process. In some embodiments, the degree of attrition of co-granules 20A, 20B is less than about 6%. In some embodiments, the degree of attrition of co-granules 20A, 20B is less than about 4%. In some embodiments, the degree of attrition of co-granules 20A, 20B is less than about 2%.

Co-granules 20A, 20B may be made by any suitable processes for producing fertilizer granules. Non-limiting examples processes for making fertilizer co-granules 20A, 20B include chemical granulation, steam/water granulation and granulation by compaction.

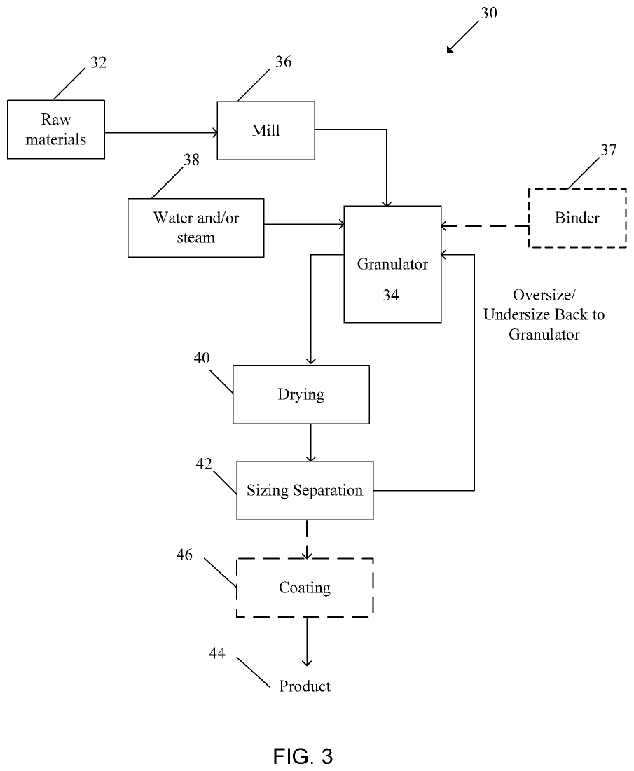

FIG. 3 illustrates a process 30 according to one example embodiment. Process 30 involves chemical granulation. In process 30, granules may be formed by accretion. In process 30, raw materials 32 are powdered, for example, by crushing or grinding in a suitable mill 36 (unless the raw materials 32 are already in the form of suitably small particles). Raw materials 32 may include struvite fines 12, polyhalite fines 14 and soluble phosphorus-containing material 22.

Raw materials 32 may include a combination of inorganic compounds used to form struvite 12 and/or polyhalite 14 and/or the soluble phosphorus-containing material 22. For example, in some embodiments, raw materials 32 include magnesium oxide (MgO), ammonia (NH₃), and phosphoric acid (H₃PO₄) to form struvite 12. In other embodiments, raw materials 32 include magnesium oxide (MgO) and monoammonium phosphate (NH₄H₂PO₄) to form struvite 12.

In some embodiments, raw materials 32 include monoammonium phosphate (NH₄H₂PO₄), diammonium phosphate ((NH₄)₂HPO₄), triple-super phosphate (also known as monocalcium phosphate with the chemical formula (CaH₄P₂O₈)) or a combination of two or more of these inorganic compounds to form the soluble phosphorus-containing material 22. Raw materials 32 may be in any suitable form, e.g., solid, gas, liquid or slurry (i.e., a semiliquid mixture).

Raw materials 32 are introduced into a granulator 34. Suitable granulators that can be used include a rotary drum, disc granulator, mechanical mixing device and roller press/compactors. In some embodiments, raw materials 32 are premixed prior to introduction into granulator 34. A mechanical mixing device such as a pug mill (not shown) may be used for the premixing. In some embodiments, raw materials 32 are mixed directly in granulator 34. The mixing facilitates uniform distribution of the raw materials, promotes the chemical reactions in forming struvite and/or the soluble water phosphorus-containing material by bringing the raw materials in close contact with each other, and assists with the encapsulation or agglomeration of the polyhalite particles into the granules. In some embodiments, one or more of raw materials 32 are introduced into granulator 34 as a slurry (i.e., mixture of one or more raw materials and water) or a binder material.

In some embodiments, water and/or steam 38 is introduced into granulator 34 in an amount sufficient to cause the raw materials to form the desired amount of struvite and agglomerate into granules having the desired size and properties. Water and/or steam 38 may be introduced into granulator 34 by injection using sprays or spargers for example. In some embodiments, a sufficient amount of water and/or steam 38 is added to raw materials 32 to form granules (granules output by granulator 34) with an excess moisture content of about 5% to about 30%, including any value therebetween, e.g., 6%, 8%, 10%, 12%, 14%, 16%, 18%, 20%, 22%, 24%, 26%, and 28%.

The particular makeup of the fertilizer granule product depends on the reaction conditions of the granulation process. Non-exhaustive reaction conditions include 1) temperature, 2) pH, 3) moisture content, 4) reaction time. For example, operating temperatures of greater than about 60° C. can limit the formation of struvite. Limited formation of struvite can have an impact on the controllability of the moisture content in the granule. In some embodiments, the operating temperatures of the granulation process are maintained at or below approximately 50° C. to 65° C., including any value therebetween, e.g., 51° C., 52° C., 53° C., 54° C., 55° C., 56° C., 57° C., 58° C., 59° C., 60° C., 61° C., 62° C., 63° C. and 64° C. The reaction conditions of the granulation process may also have an impact on the yield of the chemical reactions. For example, suboptimal reaction conditions (e.g., incomplete reactions where the reactants are not completely converted to products or two or more reactions occur simultaneously such that some reactants are converted to undesired side products) of the granulation process can lower the reaction yield, increasing the amount and/or types of impurities formed during the granulation process.

Optionally a binder 37 is added to granulator 34 to enhance granule strength and cohesiveness. Compounds such as calcium lignosulphonate, starch, guar gum, molasses binders, or the like may be used to accelerate the formation of the granule product.

Granules output by granulator 34 are dried at 40 to enhance granule strength, stop the chemical reactions, and reduce the excess moisture content in the granules. In some embodiments, the excess moisture content in the dried granule product 44 is less than about 5%, including any value therebetween, e.g., 0.1%, 0.2%, 0.3%, 0.4%, 0.5%, 0.6%, 0.7%, 0.8%, 0.9%, 1.0%, 1.5%, 2.0%, 2.5%, 3.0%, 3.5%, 4.0% and 4.5%. In some embodiments, the excess moisture content in the dried granule product 44 is less than about 2%. In some embodiments, the excess moisture content in the dried granule product 44 is less than about 1%.

Dried granules are then screened at 42 to yield product size material. Granules of sizes outside of a desired range (oversize and/or undersize) may be returned to granulator 34. In some embodiments, oversized and/or undersized granules may be crushed or pulverized prior to returning to granulator 34.

Optionally, the product 44 is coated with a coating agent at 46 to reduce dust formation and enhance product strength. Examples of suitable coating agents include waxes, petroleum products, and polymers.

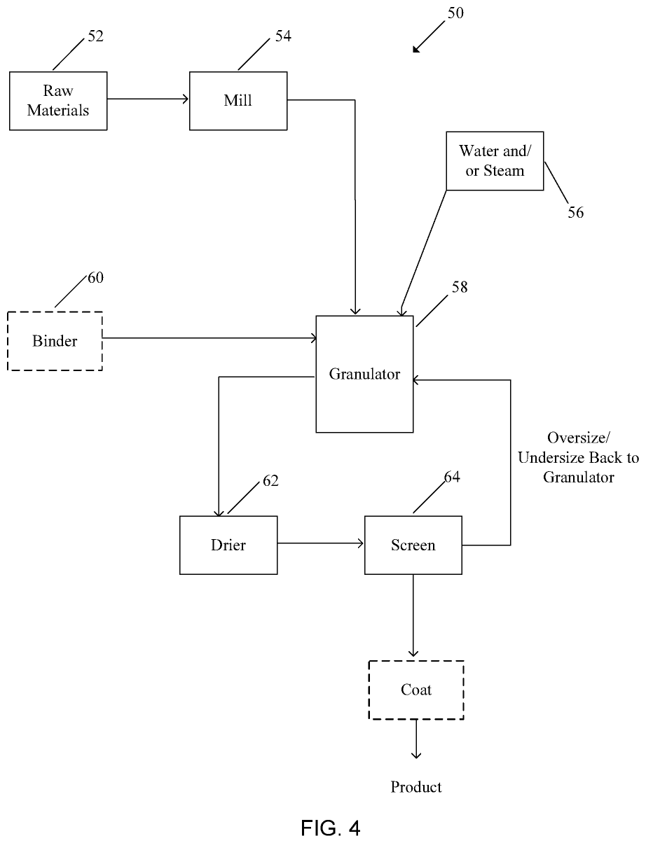

FIG. 4 illustrates a process 50 according to another example embodiment which produces fertilizer granules by steam/water granulation. In process 50, raw materials 52 are powdered, for example by crushing or grinding in a suitable mill 54 (unless the raw materials 52 are already in the form of suitably small particles). Raw materials 52 may be fine particles of struvite 12, polyhalite 14 and soluble phosphorus-containing material 22 (if such is present). A binder 60 (e.g., MAP, calcium lignosulphonates, starch or molasses etc.) may be introduced into granulator 58 to enhance agglomeration.

Optionally, raw materials which may optionally include one or more liquids, are premixed, for example in a pug mill or similar device (not shown) prior to being fed into granulator 58. Raw materials 52 may also be added into granulator 58 by a recycle path (the recycle path may carry, for example, recycle dry product and/or crushed oversize material and/or undersized material).

Granulator 58 may comprise, for example a, rotary drum, pug mill, or pan granulator. Steam and/or water 56 and/or binder 60 is introduced into granulator 58 in an amount sufficient to cause the dry raw materials to agglomerate into granules having the desired size and properties.

Granules are dried at a drier 62 and screened at a screen 64 or other size selector to separate product size granules from granules that are oversize or undersize. Oversized and undersized granules may be crushed and recycled to granulator 58. If required, the product may be coated to reduce dust formation and enhance product strength.

The granules produced by any of the methods described herein may have struvite (1% to 99% by weight), soluble phosphorus (0% to 98% by weight) and polyhalite (99% to 1% by weight) as required for a desired application. In some embodiments, the granules comprise struvite in the range of from about 73% to about 97% by weight and polyhalite in the range of from about 27% to about 3% by weight. In some embodiments, the granules comprise a combination of struvite and soluble phosphate in the range of from about 64% to about 96% by weight, and polyhalite in the range of from about 36% to about 4%.

### EXAMPLES

Tables 1 to 6 are example fertilizer compositions. The tables list the relative amounts of each starting material in the fertilizer blend, the available amounts of nitrogen, phosphorus pentoxide, potassium oxide, sulfur, calcium and magnesium from the starting material and the fertilizer blend, and the ratio of available sulfur to available phosphate expressed as phosphorus pentoxide for each example composition. Tables 1 to 3 are example fertilizer compositions with a fertilizer blend having a ratio of available sulfur to available phosphate expressed as phosphorus pentoxide of about 25%. Tables 4 to 6 are example fertilizer compositions with a fertilizer blend having a ratio of available sulfur to available phosphate expressed as phosphorus pentoxide of about 2%.

The example compositions include one of Crystal Green™, Crystal Green Synchro™, and Crystal Green Synchro2 as the source of phosphorus. Crystal Green™ is a commercially available struvite product containing 5% nitrogen, 28% total phosphate expressed as phosphorus pentoxide and 10% magnesium. Crystal Green Synchro™ is a commercially available co-granulated product comprising 38% Crystal Green™ and 62% monoammonium phosphate by weight. Crystal Green Synchro2 is a co-granulated product comprising 25% Crystal Green™ and 75% diammonium phosphate by weight. Crystal Green Synchro™ and Crystal Green Synchro2 are slow- and fast-release phosphorus materials comprising struvite and a water-soluble phosphorus-containing material.

### Example 1

TABLE 1

| | | | | | | | % of |
|---|---|---|---|---|---|---|---|
| | N | P₂O₅ | K₂O | S | Ca | Mg | Blend |
| Polyhalite | 0 | 0 | 13.5 | 18.8 | 15.4 | 3.3 | 27% |
| Crystal | 5 | 28 | 0 | 0 | 0 | 10 | 73% |
| Green ™ | | | | | | | |
| (CG) | | | | | | | |
| Blend | 3.643645 | 20.40441 | 3.662158 | 5.099894 | 4.177573 | 8.182484 | 100% |
| | | | % S/P₂O₅ | 25% | | | |

### Example 2

TABLE 2

| | | | | | | | % of |
|---|---|---|---|---|---|---|---|
| | N | P₂O₅ | K₂O | S | Ca | Mg | Blend |
| Polyhalite | 0 | 0 | 13.5 | 18.8 | 15.4 | 3.3 | 36% |
| Crystal | 9 | 43 | 0 | 0 | 0 | 3.5 | 64% |
| Green | | | | | | | |
| Synchro ™ | | | | | | | |
| (38% CG to | | | | | | | |
| 62% MAP by | | | | | | | |
| weight) | | | | | | | |
| Blend | 5.76 | 27.52 | 4.86 | 6.768 | 5.544 | 3.428 | 100% |
| | | | % S/P₂O₅ | 25% | | | |

### Example 3

TABLE 3

| | | | | | | | % of |
|---|---|---|---|---|---|---|---|
| | N | P₂O₅ | K₂O | S | Ca | Mg | Blend |
| Polyhalite | 0 | 0 | 13.5 | 18.8 | 15.4 | 3.3 | 36% |
| Crystal | 15 | 42 | 0 | 0 | 0 | 3 | 64% |
| Green | | | | | | | |
| Synchro 2 | | | | | | | |
| (25% CG to 75% | | | | | | | |
| DAP by weight) | | | | | | | |
| Blend | 9.6 | 26.88 | 4.86 | 6.768 | 5.544 | 3.108 | 100% |
| | | | % S/P₂O₅ | 25% | | | |

### Example 4

TABLE 4

| | | | | | | | % of |
|---|---|---|---|---|---|---|---|
| | N | P₂O₅ | K₂O | S | Ca | Mg | Blend |
| Polyhalite | 0 | 0 | 13.5 | 18.8 | 15.4 | 3.3 | 3% |
| Crystal | 5 | 28 | 0 | 0 | 0 | 10 | 97% |
| Green ™ | | | | | | | |
| Blend | 4.853296 | 27.17846 | 0.396102 | 0.551608 | 0.451849 | 9.803416 | 100% |
| | | | % S/P₂O₅ | 2% | | | |

### Example 5

TABLE 5

| | | | | | | | % of |
|---|---|---|---|---|---|---|---|
| | N | P₂O₅ | K₂O | S | Ca | Mg | Blend |
| Polyhalite | 0 | 0 | 13.5 | 18.8 | 15.4 | 3.3 | 4% |
| Crystal | 9 | 43 | 0 | 0 | 0 | 3.5 | 96% |
| Green | | | | | | | |
| Synchro ™ | | | | | | | |
| (38% CG to | | | | | | | |
| 62% MAP by | | | | | | | |
| weight) | | | | | | | |
| Blend | 8.598896 | 41.08362 | 0.601656 | 0.837861 | 0.686333 | 3.491087 | 100% |
| | | | % S/P₂O₅ | 2% | | | |

### Example 6

TABLE 6

| | | | | | | | % of |
|---|---|---|---|---|---|---|---|
| | N | P₂O₅ | K₂O | S | Ca | Mg | Blend |
| Polyhalite | 0 | 0 | 13.5 | 18.8 | 15.4 | 3.3 | 4% |
| Crystal | 15 | 42 | 0 | 0 | 0 | 3 | 96% |
| Green | | | | | | | |
| Synchro 2 | | | | | | | |
| (25% CG to | | | | | | | |
| 75% DAP by | | | | | | | |
| weight) | | | | | | | |
| Blend | 14.4 | 40.32 | 0.54 | 0.752 | 0.616 | 3.012 | 100% |
| | | | % S/P₂O₅ | 2% | | | |

### Example 7

The effect of a granular fertilizer comprising a slow and fast release source of phosphorus and a slow release source of sulfur was studied on a field in Portage La Prairie, Manitoba, Canada. Four different phosphorus-containing fertilizer compositions were tested against an untreated control and a Grower Standard Practice control. Each of the four phosphorus-containing fertilizer compositions and the Grower Standard Practice control contained phosphorus pentoxide. The Grower Standard Practice control (MAP) was made entirely of monoammonium phosphate (MAP) so 100% of phosphorus pentoxide came from monoammonium phosphate (MAP). Fertilizer treatment #1 (15/85B) was a blend of struvite granules and MAP granules. 15% of the phosphorus pentoxide contained in fertilizer treatment #1 came from struvite and 85% of phosphorus pentoxide came from MAP. Fertilizer treatment #2 (25/75B) was a blend of struvite granules and MAP granules. 25% of the phosphorus pentoxide contained in fertilizer treatment #2 came from struvite and 75% of phosphorus pentoxide came from MAP. Fertilizer treatment #3 (25/75S) was co-granules containing particles of struvite and MAP bound together into granules. 25% of the phosphorus pentoxide contained in fertilizer treatment #3 came from struvite and 75% of phosphorus pentoxide came from MAP. Fertilizer treatment #4 (25/75 StPo) was co-granules containing particles of struvite, MAP and polyhalite that were bound together into granules, and contained 24% by weight of struvite, 40% by weight of MAP and 36% by weight of polyhalite. 25% of the phosphorus pentoxide contained in fertilizer treatment #4 came from struvite and 75% of the phosphorus pentoxide came from MAP.

Each of the fertilizer treatments #1-4 and the Grower Standard Practice control was applied at a rate of 30 lbs/acre of phosphorus pentoxide to Canola crops. The total crop yields for each of the controls and the fertilizer treatments and the relative crop yield as compared to the controls are illustrated in the following Table 7. The total crop yields are calculated based on the average results of four test plots.

TABLE 7

| | Total | % Control | % MAP |
|---|---|---|---|
| Treatment | Yield | of Yield | of Yield |
| No fertilizer (control) | 33.1 | 100 | N/A |
| Grower Standard Practice (MAP) | 36.8 | 111 | 100% |
| #1 (15/85B) | 43.8 | 132 | 119% |
| #2 (25/75B) | 34.3 | 104 | 93% |
| #3 (25/75S) | 36.1 | 109 | 98% |
| #4 (25/75 StPo) | 37.4 | 113 | 102% |

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof; elements which are integrally formed may be considered to be connected or coupled;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B even if features A and are described in different sentences, different paragraphs, different parts of the present description and/or in reference to different drawings (unless the description states otherwise or features A and B are fundamentally incompatible).

While a number of exemplary aspects and embodiments are discussed herein, those of skill in the art will recognize certain modifications, permutations, additions and sub-combinations thereof.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

It is emphasized that the invention relates to all combinations of the above features, even if these are recited in different claims.

1. A granular fertilizer comprising:
granules comprising particles of struvite and particles of polyhalite;
wherein a weight ratio of available sulfur to available phosphate expressed as phosphorus pentoxide is in the range of from about 2% to about 25%.

2. (canceled)

3. The granular fertilizer according to claim 1, wherein the particles of struvite and the particles of polyhalite each have sizes of about SGN 10 or less.

4. The granular fertilizer according to claim 1, wherein the weight ratio of available sulfur to available phosphate expressed as phosphorus pentoxide is about 3% to about 8%.

5. (canceled)

6. The granular fertilizer according to claim 1, wherein the granules further comprise particles of a water-soluble phosphorus containing material.

7. The granular fertilizer according to claim 6, wherein the water-soluble phosphorus containing material comprises one or more of: phosphoric acid, single super phosphate, double super phosphate, triple super phosphate, monoammonium phosphate, diammonium phosphate, and dicalcium phosphate.

8. The granular fertilizer according to claim 6 wherein the water-soluble phosphorus containing material is intermixed with the particles of struvite to form phosphorus-containing granules that are intermixed with the particles of polyhalite in the granules.

9. The granular fertilizer according to claim 1, wherein the fertilizer has a struvite content in the range of from about 65% to about 99% by weight and has a polyhalite content in the range of from about 35% to about 1% by weight.

10. The granular fertilizer according to claim 8, wherein the fertilizer has a struvite content in the range of from about 73% to about 97% by weight, and has a polyhalite content in the range of from about 27% to about 3% by weight.

11. The granular fertilizer according to claim 6 wherein the fertilizer has a struvite content in the range of from about 15% to about 35% by weight and has a water-soluble phosphorus containing material content in the range of from about 30% to about 50% by weight.

12. (canceled)

13. The granular fertilizer according to claim 11 wherein the fertilizer has a polyhalite content in the range of from about 20% to about 50% by weight.

14. (canceled)

15. The granular fertilizer according to claim 11 wherein the granules comprise phosphorus pentoxide and about 15% to about 35% by weight of the phosphorus pentoxide contained in the granules is sourced from struvite and about 65% to about 85% by weight of the phosphorus pentoxide contained in the granules is sourced from the water-soluble phosphorus containing material.

16. The granular fertilizer according to claim 8 wherein the fertilizer has a content of the phosphorus-containing granules in the range of from about 55% to about 99% by weight, and has a polyhalite content in the range of from about 1% to about 45% by weight.

17. (canceled)

18. The granular fertilizer according to claim 16 wherein the phosphorus-containing granules comprise struvite and the water-soluble phosphorus-containing material, and wherein the phosphorus-containing granules have a struvite content in the range of from about 15% to about 35% by weight.

19. (canceled)

20. The granular fertilizer according to claim 18 wherein the phosphorous-containing granules contain phosphorus pentoxide and about 15% to about 35% of the phosphorus pentoxide contained in the phosphorous-containing granules is sourced from the struvite and 65% to 85% of the phosphorus pentoxide contained in the phosphorous-containing granules is sourced from the water-soluble phosphorus containing material.

21. The granular fertilizer according to claim 1 further comprising a binder wherein the binder comprises calcium lignosulphonate, starch, molasses, MAP, a reactively formed struvite or a reactively formed water-soluble phosphorus containing material.

22. (canceled)

23. The granular fertilizer according to claim 1 further comprising one or more of: dittmarite, schertelite, periclase, langbeinite and gypsum.

24.-26. (canceled)

27. The granular fertilizer according to claim 1, wherein the crush strength of the granules is greater than about 3 lbs.

28. (canceled)

29. The granular fertilizer according to claim 1, wherein the degree of attrition of the granules is less than about 6%.

30. (canceled)

31. The granular fertilizer according to claim 1 wherein the granules consist essentially of struvite and polyhalite.

32. The granular fertilizer according to claim 6, wherein the granules consist essentially of struvite, the water-soluble phosphate-containing material, and polyhalite.

33. The granular fertilizer blend comprising:
particles of struvite and particles of polyhalite;
wherein a weight ratio of available sulfur to available phosphate expressed as phosphorus pentoxide is in the range of from about 2% to about 25%.

34.-111. (canceled)

113. The granular fertilizer according to claim 18 wherein the phosphorus-containing granules have a water-soluble phosphorus containing material content in the range of from about 30% to about 50% by weight.
